(19) United States
(12) Patent Application Publication
(10) Pub. No.: US 2010/0208006 A1
(43) Pub. Date: Aug. 19, 2010

(54) PRINTING BIO-REACTIVE MATERIALS

(75) Inventor: Richard Selinfreund, Terre Haute, IN (US)

Correspondence Address: Trellis Intellectual Property Law Group, PC, 1900 EMBARCADERO ROAD, SUITE 109, PALO ALTO, CA, 94303, US

(73) Assignees: SONY CORPORATION, Tokyo (JP); SONY DADC US INC., Terre Haute, IN (US)

(21) Appl. No.: 12/707,625

(22) Filed: Feb. 17, 2010

Related U.S. Application Data
(60) Provisional application No. 61/153,535, filed on Feb. 18, 2009.

(51) Int. Cl. B41J 2/045; B41J 2/01

(52) U.S. Cl. 347/68; 347/102

(57) ABSTRACT

A method for printing one or more desired features on a polymeric substrate. In an example embodiment, the method includes receiving an ink that includes a bio-reactive indicator material, and employing a piezoelectric printhead to deposit the ink on a polymeric substrate. The polymer substrate with the ink deposited thereon represents a diagnostic testing device for performing a test on a material sample. The method further includes employing UltraViolet (UV) light to cure the ink. The ink may include an electrically conductive material. A UV light source may be coupled to a piezoelectric printhead and actuated in response to a control signal from a controller to facilitate curing materials deposited on the polymeric substrate.

### CROSS REFERENCE TO RELATED APPLICATIONS

This application claims priority from U.S. Provisional Patent Application Ser. No. 61/153,535, entitled LOW COST, HIGH SPEED METHOD FOR PRINTING BIO-MATERIALS ONTO POLYMERIC MATERIALS, filed on Feb. 18, 2009, which is hereby incorporated by reference as if set forth in full in this application for all purposes.

### BACKGROUND OF THE INVENTION

This application relates in general to printing and more specifically relates to systems and methods for printing features, such as structures including biological materials for diagnostic medical testing, on polymer substrates.

Systems and methods for creating features on polymer substrates are employed in various demanding applications, including creation of In Vitro Diagnostic (IVD) medical tests, Micro ElectroMechanical Systems (MEMS) devices, Polymerase Chain Reaction (PCR) tests for analyzing deoxyribonucleic Acid (DNA) sequences, and so on. Such applications often demand high-speed cost-effective systems and methods capable of carefully and accurately forming features on polymeric substrates without damaging the features or deposited substances.

For the purposes of the present discussion, a polymeric material, also called a polymer material, may be any material with repeating structural units typically connected by covalent bonds. Examples of polymeric material include plastics, such as polycarbonate, rubber, silicone, and biopolymers, such as proteins and cellulose.

Cost-effective, high speed, and accurate methods for creating features on polymer substrates are particularly important for creating medical diagnostic tests, which often must be created in high volume to meet increasing demands of the medical and research communities. Furthermore, materials used to create the tests are often susceptible to damage during creation of the tests.

Conventionally, the creation of desired features on polymeric substrates may involve expensive lithographic processes and careful deposition of materials on the substrates. The materials may be positioned via robotic pick-and-place assemblies. After positioning materials, such as proteins and reactants, on the sample, the materials are cured. The curing process may involve a lengthy drying process. Attempts to cure and/or dry the materials via baking have proven problematic, since polymer substrates tend to warp, and sensitive chemicals used for diagnostic testing may become damaged when exposed to excessive heat from a baking oven.

In addition, conventional methods for forming features on polymeric substrates often offer only relatively crude control over device tolerances that can result in inconsistent features in the final product.

### SUMMARY

One embodiment for printing one or more desired features on a substrate, such as polymer, includes using an ink that includes an indicator material, and employing a piezoelectric printhead to deposit the ink on the substrate. An indicator material may be any material or substance that reacts to a bio-material in a reproducible manner to leave a reactive deposit. In a preferred embodiment one or more reactive deposits are used to diagnose a medical condition of a person by reacting to a human byproduct, such as a bodily fluid (e.g., saliva, blood, sweat, tears, breath vapor, etc.) or other bodily matter (e.g., skin, hair, tissue sample, fecal matter, etc.) whether solid, liquid or gas of the person to produce a medical diagnostic result or indication. In another embodiment the reactive deposit can be used to provide a result by passing a conductive current through a biological sample. An indicator may be adapted to selectively change in a predetermined way in the presence of a predetermined chemical or substance, thereby providing an indication of the presence of or a particular concentration of the chemical or substance.

In a specific implementation, the polymer substrate with the ink deposited thereon represents a diagnostic testing device for performing a test on a material sample. The method further includes employing UltraViolet (UV) light to cure the ink.

The method further includes employing the piezoelectric printhead with a UV light source coupled thereto, to facilitate curing materials deposited on the polymeric substrate. The UV light source and printhead are connected to a controller.

A piezoelectric printhead and a reservoir of etchant may be employed to selectively etch the polymer material, thereby creating a substrate with one or more etched features thereon or therein. Examples of etched features include microfluidic channels. After creation of the etched features, the piezoelectric printhead is used to selectively deposit the ink in a predetermined spatial relationship relative to the one or more etched features.

Additional features, such as lenses, may be created on the polymeric substrate as needed, such as via deposition of UV-curable drops of lens material thereon. The printhead may include a Drop On Demand (DOD) printhead that is coupled to a fiber optic strand, wherein the fiber optic strand is adapted to convey UV light.

Embodiments herein can be facilitated by the use of a non-contact printing methodology to create features on a polymeric substrate. The features may include proteins, indicator materials, medical diagnostic testing materials, and so on. In a preferred embodiment the features are three-dimensional but mechanisms and methods discussed herein may be adapted for two or substantially one dimensional structures.

### BRIEF DESCRIPTION OF THE DRAWINGS

FIG. 1 is a diagram of an example system for printing features on a polymeric substrate.

FIG. 2 is a diagram of an example assembly line that employs the system of FIG. 1 to create multiple diagnostic testing devices on polymeric substrates.

FIG. 3 is a flow diagram of a first example method adapted for use with the system of FIG. 1.

FIG. 4 is a flow diagram of a second example method adapted for use with the system of FIG. 1.

FIG. 5 is a flow diagram of a third example method adapted for use with the system of FIG. 1.

### DETAILED DESCRIPTION OF EMBODIMENTS

Although the description has been described with respect to particular embodiments thereof, these particular embodiments are merely illustrative, and not restrictive. While the present description primarily addresses apparatuses, systems, and methods for printing biological materials and related features on a substrate for medical diagnostics, embodiments are not limited thereto. For example, printing devices and methods discussed herein may be employed in various different applications that may require deposition of other types of very small features on a polymer substrate. Example applications include printing certain reflective materials or mirrors on the polymer substrate for optics applications.

For clarity, certain well-known components, such as computers, hard drives, processors, operating systems, user interfaces, power supplies, printhead flex circuits, and so on, have been omitted from certain figures. However, those skilled in the art with access to the present teachings will know which components to implement and how to implement them to meet the needs of a given application.

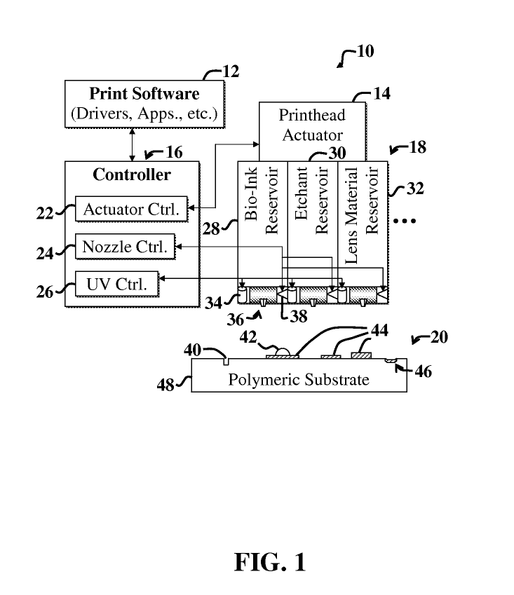

FIG. 1 is a diagram of an example system 10 for printing features 40-46 on a polymeric substrate 48. The system 10 includes a special piezoelectric printhead 18 connected to a printhead actuator 14. The piezoelectric printhead 18 further includes a bio-ink reservoir 28, an etchant reservoir 30, and a lens-material reservoir 32. Each reservoir 28-32 is coupled to a respective print nozzle 36, nozzle actuator 38, and UltraViolet (UV) light source 34. In general, any type of suitable curing approach may be used such as heat cure, laser cure, etc. The ink may include an electrically conductive material.

The printhead actuator 14 and the printhead 18 communicate with a printer controller 16, which includes an actuator controller 22 for controlling the printhead actuator 14, a nozzle controller 24 for controlling nozzles 38, and a UV controller 26 for controlling the UV light sources 34. The printer controller 16 further communicates with print software 12, which may include drivers, applications used for designing features to be created via the system 10, and so on.

In operation, the system 10 is adapted to print features 40-46 on a polymeric substrate 48. The features 40-46 may exhibit micrometer-scale dimensions depending upon the application. A micrometer-scale dimension may be any dimension less than approximately 500 micrometers. The printhead 18 is adapted to remain further than one-half an inch from the polymeric substrate 48 to facilitate curing via the UV light sources 34 and to prevent any damage to the features 40-46 that could otherwise result from contact of the print head 18 with the features 40-46. In the present embodiment, the print head 18 is positioned approximately one inch from the surface of the polymeric substrate, however larger or smaller distances are also possible.

Note that while in the present example embodiment, only one printhead 18 is shown for illustrative purposes, in practice, the system 10 may include several printheads. The exact number of printheads employed in a given implementation is application specific and may be readily determined by those skilled in the art to meet the needs of a given application. Furthermore the printhead 18 may include more or fewer reservoirs and accompanying print nozzles 36 than the three reservoirs 28-32 shown.

For illustrative purposes, the features 40-46 created in or on the polymeric substrate 48 include a micro channel 40. The micro channel 40 may be a microfluidic channel, which may be used for transporting fluids, such as via capillary action, on the surface of the polymeric substrate 48 to meet the needs of a given application. For the purposes of the present discussion, a microfluidic channel may be any channel, groove, or tube characterized by one or more dimensions smaller than 20 microns, wherein the channel is suitable for the transport of a certain fluid therein or therethrough.

The example features 40-46 further include a printed lens 42, which is disposed on selectively deposited bio-indicator material 44. For illustrative purposes, some bio-indicator material is shown deposited beneath the lens 42, which is formed thereon. For the purposes of the present discussion, a biological material may be any material derived from a life form either alive or dead. Biological materials are often organic materials, such as proteins, DNA fragments, and so on. An indicator material may be any material or substance that is adapted to selectively change in a predetermined way in the presence of a predetermined chemical or substance, thereby providing an indication of the presence of or a particular concentration of the chemical or substance. Note that indicator materials are not limited to detecting the existence of a substance, but certain indicator materials may also facilitate detection of concentrations of certain chemicals or substances within a sample applied to the indicator material. A bio-indicator material may be any material that is both a biological material and an indicator material.

Hence, the system 10 represents a piezoelectric printing device capable of printing various features 40-46 on a polymer or polymeric substrate 48, including microlenses, such as a lens 42, biological materials, such as, such as proteins, Polymerase Chain Reaction (PCR) reactants, medical diagnostic indicator materials 44, e.g., for measuring cholesterol, and so on, as discussed more fully below. The system 10 may also selectively deposit biological materials 44 in, on, and/or in a desired spatial relationship relative to three-dimensional features etched in the polymeric substrate 48, as discussed more fully below.

For the purposes of the present discussion, a printing device may be any device capable of outputting a desired pattern of material in response to a control signal from a controller. A piezoelectric printhead may be any printhead that is adapted to work with a material that generates a force in response to application of a predetermined voltage or current. Such materials are called piezoelectric materials. Piezoelectric printheads may employ inks containing piezoelectric materials. In cases where piezoelectric inks are employed, application of a voltage or current across a printhead nozzle filed with the ink results in ejection of the ink from the nozzle. Alternatively, the printhead may employ a piezoelectric crystal that is actuated via a voltage or current to produce an acoustic shockwave used to force materials to be printed from a nozzle of the printhead. A printer employing a piezoelectric printhead is called a piezoelectric printer or a piezoelectric printing device.

In an example operative scenario, a user of the system 10 employs the print software 12 to design a desired layout of features to be printed on the polymeric substrate 48 via the print software 12. In the present case, the designed features include the features 40-46. The features 40-46 are collectively called the scene to be printed.

After the desired print scene is designed, the user employs the print software 12 to activate the controller 16. The controller 16 then controls movement of the printhead 18 via issuance of control signals to the actuator 14 and further controls the timing and dispersal of materials from each of the reservoirs 28-32 via issuance of appropriate control signals to the nozzle actuators 38.

In the present specific example embodiment, the reservoirs 28-32 include UV-curable materials, i.e., materials that harden or otherwise change characteristics appropriately in response to application of UV energy. UV materials are considered to be photo-reactive materials, since one or more material properties thereof may be changed via application of photons of a desired wavelength and intensity. For the purposes of the present discussion, a UV light source may include any device capable of outputting electromagnetic energy characterized by a center wavelength that is between 150 nm and 450 nm in length. Similarly, UV light may be any electromagnetic energy characterized by a center wavelength that is between 150 nm and 450 nm in length.

Generally, the materials in the reservoirs 28-32 are non-Newtonian fluids, however other types of fluids may be used. For the purposes of the present discussion, a non-Newtonian fluid may be any fluid not characterized by a single uniform constant viscosity.

The bio-ink reservoir 28 includes an indicator material that when printed on the polymeric substrate 48 and cured, may be used to detect or sense a substance or concentration of the substance. For example, the indicator material may include chemicals, such as Dil-LDL marker materials, for measuring Low Density Lipoprotein (LDL) or Polymerase Chain Reaction (PCR) reactants. The PCR materials may include, for example, a solution of twenty-five percent toluene, and seventy-five percent phenoxy 2-propanol; or fifteen percent tolulene, fifty percent phenoxy 2-propanol, and thirty-five percent methyl methacrylate; or seventy-five percent ethanol and twenty-five percent propane, 1,2,3 triol. Ethanolamine may also be added to the solution. Note that other formulations and percentages are also possible. Suitable color change reporter molecules may be included. Applicable color change reporter molecules may be characterized by example center absorbance wavelengths at or near 780 nm, 650 nm, or 405 nm. Judicious use of color change reporter molecules may facilitate tuning the indicator optical density before reaction and after reaction to desired wavelengths.

Note that the bio-ink reservoir 28 may also include an electrically conductive material to facilitate piezoelectric actuation of the printer nozzles 36. Furthermore, note that electrically conductive materials may be further employed in various medical and research applications. For example, conductive polymer materials may be used to deposit circuitry on a polymer substrate, where the circuits may be used to measure the resistivity of samples applied thereto, thereby providing an indication of the material composition of the composition of the material sample.

The indicator material in the bio-ink reservoir 28 may be an ink containing proteins, wherein the ink includes enzyme binding buffer, glycerol (instead of phenoxy 2-propanol). The wavelengths of light used to read the resulting printed bio materials may coincide with maximum reflectivity or optical absorption characteristics of the materials. For example, in the present embodiment, indicator optical density values are tuned to match desired wavelengths, before and after reaction with a substance to be analyzed. This tuning may be performed by those skilled in the art with access to the present teachings without undue experimentation, such as by manipulating the ratios of particular ingredients in the bio-ink reservoir 28.

The bio-inks and accompanying indicator materials in the bio-ink reservoir are adapted to bond the polymeric substrate 48 via a cross-linking reaction, which results in cross-linked bonds, the bonds of which endure when cured via the UV light sources 34. For the purposes of the present discussion, a cross-linked bond may be any chemical or mechanical bond facilitated by a reaction between one or more carbon chains in a polymer material. An example suitable polymeric substrate material for facilitating cross-linked bonds with deposited materials includes Poly Methyl Methacrylate (PMMA).

The bio-inks may include additional components, such as silver, and ethanol to facilitate flash evaporation in response to application of UV light.

In the present embodiment, UV curing via the light sources 34 includes application of UV laser pulse light characterized by a center wavelength between 200 nm and 300 nm. Energy density of the laser pulse light is approximately 200 joules to 1000 micro jules per square centimeter. In a particular implementation, the energy density is approximately 400 joules per square centimeter. The laser pulse duration is approximately 5 milliseconds in the present example embodiment. Note that the exact combination of UV laser wavelength, pulse length, energy density, and so on for a given polymeric substrate and material to be cured may be application specific and may depend upon the materials used, and the distance between the printhead 18 and the polymeric substrate 48. In the present embodiment, the nozzles 36 of the printhead 18 are approximately 1 micrometer from the surface of the polymeric substrate 20.

An example ink that may be used to mix with certain bio indicator materials usable with embodiments disclosed herein includes conductive ink from Cabot Corporation (catalog number CCI-300), which is located in Albuquerque, N. Mex.

An example laser that may be employed as a source of UV light to feed the light sources 34 when the light sources represent fiber optic filaments or strands is a single-pulsed UV Ophir laser.

The etchant reservoir 30 includes a material capable of etching the polymeric substrate. For example, the etchant may include a solution of seventy percent Methyl Ethyl Ketone (MEK) and thirty percent 2-ethylhexyl-2-cyano-3,3-diphenyl acrylate.

The lens-material reservoir 32 includes a lens material that remains in a liquid state until cured, and upon cure remains clear. The lens 42 may be formed via deposition of a spot of lens material on the polymeric substrate 48. The size and shape of the spot may be controlled by adjusting the amount of lens material deposited to the spot corresponding to the lens 42 and the viscosity of the lens material. The viscosity of the lens material may be adjusted by selectively altering the material formulation. an example, lens material formulation includes a mixture of PMMA and/or PolyDiMethylSiloxane (PDMS), water, polyvinyl alcohol, Irgacure (184 ratios, 2-4%). Note that the polymer substrate 48 may also be made from PMMA and/or PDMS.

In one operative scenario, the printhead 18 and nozzles 36 are actuated to first employ etchant from the etchant reservoir 30 to etch the polymeric substrate, forming three-dimensional substrate features, such as the microfluidic channel 40 and a groove for accommodating indicator material 46. The UV light sources 34 are then actuated to illuminate areas where etchant was deposited, thereby accelerating vaporization and removal of the etchant from the polymeric substrate 48. Indicator materials from the bio-ink reservoir 28 are then deposited on the substrate 48 and cured via the UV light sources 34 before the lens material 42 is deposited at desired locations on the substrate 48. Note that deposition of the indicator materials 44, the lens material 42, and creation of the etched substrate features 40, 46 may be performed in any applicable order or simultaneously if desired for a particular application. Furthermore, all of the features 40-46 may be formed via a single pass of the printhead 18. Note however, that multiple passes may be employed without departing from the scope of the present teachings.

Note that while in the present illustrative embodiment, three different fluid reservoirs 28-32 are coupled to different nozzles 36 capable of separate actuation, more or fewer reservoirs may be employed, and the reservoirs may contain materials not discussed herein. Furthermore, the fluid reservoirs 28-32 need not be part of the printhead assembly 18. For example, the fluid reservoirs 28-32 may be positioned remotely from the printhead 18 while still delivering materials contained therein through ducts or tubes.

Exact details of the materials in each of the reservoirs 28-32 are application specific. Those skilled in the art with access to the present teachings may select appropriate materials to meet the needs of a particular application without undue experimentation.

After dispersal of a desired material from one or more of the reservoirs 28-32, the material(s) may be cured via selective actuation of the UV light sources 34 via the UV controller 26. Note that in the present specific example embodiment, the UV light sources may be individual Light Emitting Diodes (LEDs), or alternatively switchable fiber optic strands, also called fiber optic waveguides, used to divert UV light from a different source.

The printhead actuators 38 may include a piezoelectric crystal that generates a shock wave sufficient to disperse fluid from one or more of the accompanying reservoirs 28-32 in response to an appropriate control signal from the controller 16. Note that other types of piezoelectric fluid dispersal mechanisms may be employed without departing from the scope of the present teachings. For example, the inks and other materials contained in the reservoirs 28-32 may include piezoelectric material that is responsive to application of an electrical current or voltage thereto. Application of an appropriate voltage or current across or at the nozzles 36 may be sufficient to disperse appropriate fluid from the reservoirs 28-32. Furthermore, note that other types of printing mechanisms other than piezoelectric printing mechanisms may be employed in certain implementations without departing from the scope of the present teachings.

The printhead 18 may be considered a Dot-On-Demand device, which may be used to place a dot of material at a desired location on demand. Note that the print software 12 may be adapted to direct the controller 16 to cause the printhead 18 to place several dots of material at a particular location on the polymeric substrate 28 in a given pass of the printhead over the polymeric substrate 48. This may be particularly useful for creating certain three dimensional structures formed by selective creation of thick and thin areas of deposited material. Furthermore, a particular deposition of the material, as illustrated by the printed bio material features 44, may include several layers of different types of bio materials from different reservoirs to create an indicator or test material that is sensitive to a broad range of concentrations of chemicals in a particular sample to be analyzed. Note that while the printhead 18 is shown including only three reservoirs, additional reservoirs including different types of bio-indicator materials may be employed.

In the present example embodiment, the substrate 48 and accompanying features 40-46 formed thereon or therein may collectively be considered a diagnostic testing device. For the purposes of the present discussion, a diagnostic testing device may be any apparatus, system, or deposited material or structure or collection thereof that is adapted to test a sample for a particular chemical or substance or concentration thereof.

The system 10, i.e., printing device, as disclosed may print spot sizes of two micrometers or less, with positional and size tolerance of approximately 1 micrometer or less. Use of stable printing formulas for use with a new class of piezoelectric printers may enable not only printing of two micrometer spots, but the production of micro channels, lenses, such as those used for signal-to-noise ration amplification, and so on.

A reader for reading and inspecting the features 40-46 may be employed for analysis and obtaining certain test results. An optical pick-up unit may be employed to read at 780 nm, 650 nm or 405 nm. Accordingly, reporter molecules used in indicator materials may be tuned with optical densities at or near such wavelengths.

In an application involving printing on a polycarbonate substrate, suitable solvents for use with the materials in the reservoirs 28-32 may include, but are not limited to Methyl Ethyl Ketone (MEK), 1-cyclopentane, and so on. Capping materials may be printed over the features 40-46 via an additional or different reservoir and printhead or reservoir. An example capping material includes, but is not limited to PMMA, MA (MethAcrylate), cyclopentane, and so on,

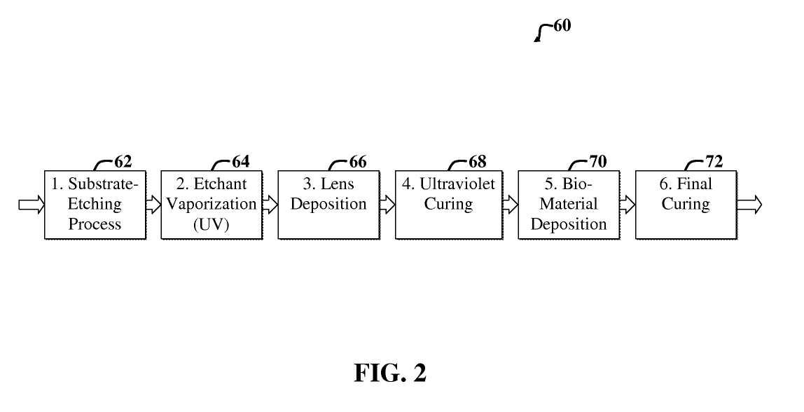

FIG. 2 is a diagram of an example assembly line 60 that employs the system 10 of FIG. 1 to create multiple diagnostic testing devices on polymeric substrates. Note that certain process stages 62-72, such as the etchant vaporization process stage 64, may be omitted, reordered in the processing sequence, or interchanged with different process stages without departing from the scope of the present teachings. Furthermore, one or more of the various stages 62-72 may be performed in parallel or approximately simultaneously via a single pass of one or more printheads. In addition, the assembly line 60 may be employed to create other Microstructured Polymeric Devices (MPD), and not just diagnostic testing devices. For example, machine readable MPD devices can be created; special polymeric capping materials may be deposited over the MPD devices to cap the devices and enhance stability and longevity of the devices, and so on.

In the present illustrative embodiment, multiple substrates, which may be polymeric wafers, are fed into the process 60 at a first etching process stage 62. At the etching process stage 62, three dimensional features, such as fluidic channels, pits, or other desired features are etched in the polymeric wafers via application of an etchant via a printing device, such as illustrated via the system 10 of FIG. 1. The wafers are then fed to an etchant vaporization process stage 64.

In the etchant vaporization process stage 64, UV light is employed to vaporize and remove etchant from the wafers before the wafers are fed to a lens-deposition process stage 66. The lens-deposition process stage 66 involves depositing lens material in or at predetermined desired locations on each wafer.

The deposited lens material is then cured via an ultraviolet curing process stage 68. At this stage UV light is employed to cure deposited lens materials via application of UV light to the locations on the wafers where the lens materials was deposited. The wafers are then feed to a bio-material deposition process stage 70.

In the bio-material deposition process stage 70, bio materials, such as materials used in medical diagnostic tests, are deposited at predetermined desired locations on the wafers before the deposited bio materials are cured via application of UV light in a final curing process stage 72.

Note that the smallest time interval between successive output of a wafer from the final curing process stage 72 corresponds to the lengthiest one of the process stages 62-72.

Use of processes in accordance with the present teachings, such as those illustrated in FIG. 2, may obviate the need to assemble small structures on polymeric substrates via pick-and-place assemblies, as features and parts may be formed in-line or at-line.

Furthermore, note that materials and combinations of materials discussed herein may be employed without departing from the scope of the present teachings. For example, lenses may be created using combinations of materials with different indices of refraction, thereby allowing customizable depth of focus.

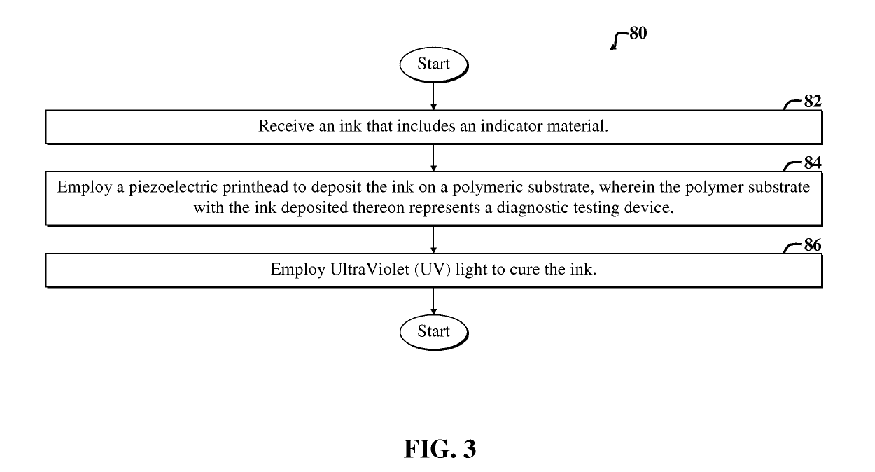

FIG. 3 is a flow diagram of a first example method 80, which is adapted for use with the system 10 of FIG. 1 for creating a diagnostic testing device. The method 80 includes a first step 82, which includes receiving an ink that includes an indicator material.

A second step 82 includes employing pone or more piezoelectric printheads to deposit the ink onto a polymeric substrate, wherein the polymeric substrate with the ink deposited thereon represents a diagnostic testing device.

A third step 84 includes employing UV light to cure the ink, where the UV light may be applied via one or more light sources coupled to each of the one or more piezoelectric printheads.

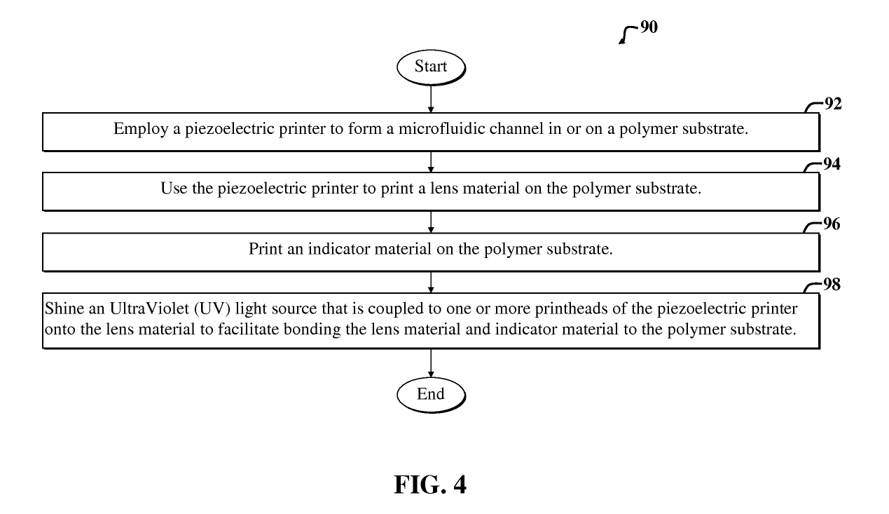

FIG. 4 is a flow diagram of a second example method 90 for creating one or more desired features on a polymer substrate, the method of which is adapted for use with the system 10 of FIG. 1. The second example method 90 includes a channel-forming step 92, which includes employing a piezoelectric printer to form a microfluidic channel in or on a polymer substrate.

A subsequent lens-deposition step 94 includes using the piezoelectric printer to print a lens material on the polymer substrate.

Next, an indicator-printing step 96 includes printing an indicator material on the polymer substrate.

Finally, a curing step 98 includes shining an UltraViolet (UV) light source, which is coupled to one or more printheads of the piezoelectric printer, onto the lens material to facilitate bonding the lens material and indicator material to the polymer substrate and to facilitate hardening and curing the lens material.

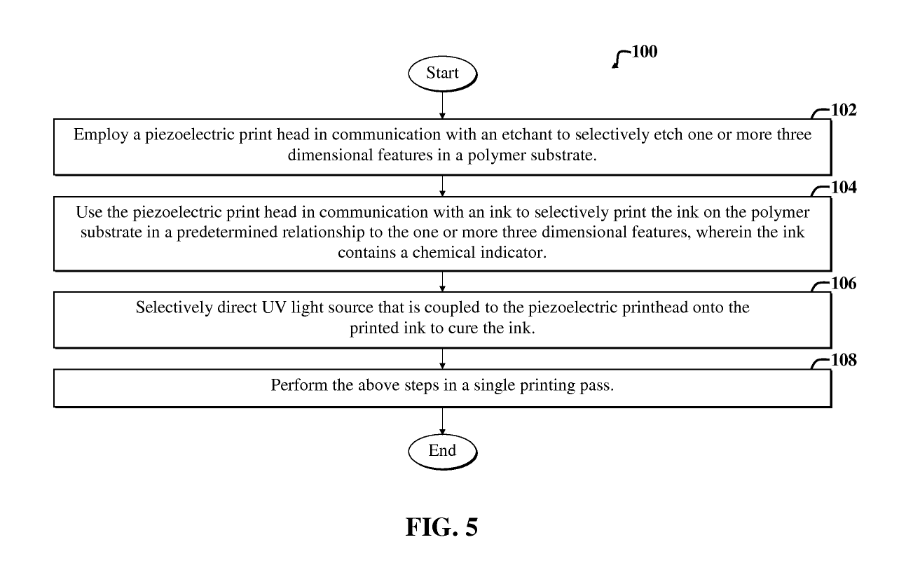

FIG. 5 is a flow diagram of a third example method 100 adapted for use with the system 10 of FIG. 1. The third example method 100 includes an initial etching step 102, which includes employing a piezoelectric printhead in communication with an etchant to selectively etch one or more three dimensional features in a polymer substrate.

A subsequent indicator-deposition step 104 includes using the piezoelectric printhead in communication with an ink to selectively print the ink on the polymer substrate in a predetermined relationship to the one or more three dimensional features that have been etched in or on the substrate, wherein the ink contains a chemical indicator.

Next, a UV-curing step 106 includes selectively directing a UV light source, which is coupled to the piezoelectric printhead, onto the printed ink to cure the ink.

A final step includes performing the above steps 102-106 via a single printing pass. For the purposes of the present discussion, a single printing pass may refer to any set of depositions of material on a substrate, whether performed in parallel or in serial, where the depositions are performed without removal of the substrate from the region beneath the printer (e.g., for baking or other steps) and without the need for a substantial delay between successive printing operations. A substantial delay may be any delay longer than 1 second.

Note that the methods disclosed in FIGS. 3-5 are not exhaustive of possible methods falling within the scope of the present teachings. For example, an another alternative method includes employing a piezoelectric printer to print a non-Newtonian fluid onto a polymeric substrate to build hemispherical lenses, microfluidic channels, medical indicators, all via a single printing pass or process step in a non-contact manner.

Another example method includes dissolving medical indicator materials in to a printing formulation with a tuned viscosity for printing. The mixed formulation may be adapted to cross-link to the polymer substrate, thereby enhancing shelf life and stability of the final product. The mixed formulation may include polyvinyl alcohol as a solvent, which may facilitate curing. Print spot sizes may be approximately two micrometers, but other spot sizes are possible. In this example alternative method, non-Newtonian fluids to be printed have maximum particle sizes of nine micrometers.

Various inks may be suitable for use with embodiments built in accordance with the present teachings. For example, various photo-reactable compounds that polymerize to a hardened surface in response to application of UV light, i.e., compounds that undergo photopolymerization may be employed. Such compounds may include photo-initiators, such as a light-activated catalyst, which decomposes into reactants that react with oligomers in the ink to initiate polymerization, resulting in a polymeric film containing desired fillers and pigments.

Dyes and pigments used may be filtered via a 0.2 micrometer filter to improve performance in certain applications. An example dye includes 25 ml Methyl MethAcrylate (MMA), such as that available via Aesar (alpha Aesar MMA, Cat #13010), in combination with 0.25 ml of dye diluted in cyclopentane to facilitate production of very small spot sizes less than 60 micrometers.

Deposited inks and materials may facilitate so-called dual-mode separation. For example, in certain implementations, such as printing of acrylic acid-co-styrenesulfonic acid-co-vinylsulfonic acid on certain nanoclusters of proteins may enable both electrostatic and hydrophobic interactions with the protein to be used to enhance specificity for targeted products. This dual mode separation may be useful in various applications, such as recovery of proteins from complex mixtures.

Inks and accompanying indicators may be printed onto a particular region on a polymer substrate, resulting in indicators with overlapping specificity to reduce generation of false positive and false negative indications returned via the resulting diagnostic testing device.

Hence, while certain embodiments for creating medical diagnostic testing devices and micro-scale features, such as channels and lenses, have been discussed, other applications are possible. Although piezoelectric printing has been primarily discussed, other forms of non-contact printing (e.g., drop on demand, quill and pen, continuous ink-jet, etc.) may be employed.

Any suitable programming language can be used to implement the routines of particular embodiments (such as routines included in print software, controllers, etc.). Example programming languages include C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for printing a bio-reactive structure on a substrate, the method comprising:
receiving an ink that includes an indicator material, wherein the indicator material is reactive to a human byproduct; and
employing a non-contact printhead to deposit the ink on the substrate to form a three-dimensional structure, wherein the three-dimensional structure includes the bio-reactive structure for use in a medical diagnosis.

2. The method of claim 1, wherein the substrate includes a polymer.

3. The method of claim 1, further including employing UltraViolet (UV) light to cure the ink.

4. The method of claim 3, wherein the ink includes an electrically conductive material.

5. The method of claim 3, wherein employing includes employing the piezoelectric printhead with a UV light source coupled thereto, wherein the UV light source is in communication with a controller.

6. The method of claim 1, further including employing the piezoelectric printhead and a reservoir of etchant to selectively etch the polymer material, thereby creating a substrate with one or more etched features thereon or therein.

7. The method of claim 6, wherein the one or more features include one or more microfluidic channels.

8. The method of claim 6, further including employing the piezoelectric printhead to selectively deposit the ink in a predetermined spatial relationship relative to the one or more etched features.

9. The method of claim 2, wherein the ink includes a non-Newtonian fluid.

10. The method of claim 9, further including employing the piezoelectric printhead and a reservoir with liquefied lens material therein to print a microlens on the substrate.

11. The method of claim 10, further including curing printed liquefied lens material via a device adapted to output UV light, the device coupled to the printhead and a controller.

12. The method of claim 1, wherein the printhead includes a Drop On Demand (DOD) printhead coupled to a fiber optic strand, wherein the fiber optic strand is adapted to convey UV light.

13. The method of claim 1, wherein the substrate includes polydimethylsiloxane (PDMS).

14. The method of claim 1, wherein the ink is characterized by one or more photo-reactive compounds.

15. The method of claim 14, wherein the ink is adapted to form cross-linked bonds to the polymer substrate that endure after the ink is cured via UV light.

16. The method of claim 1, wherein the piezoelectric printhead is adapted to not contact the polymer substrate during printing.

17. The method of claim 16, wherein the piezoelectric printhead is adapted to remain further than ½ of an inch from the polymeric substrate.

18. The method of claim 2, wherein the printhead includes a piezoelectric crystal adapted to output an acoustic wave to facilitate forcing the ink and the indicator material from one or more printhead nozzles.

19. A piezoelectric printing apparatus comprising:
a piezoelectric printhead;
an UltraViolet (UV) light source coupled to the piezoelectric printhead;
a controller in communication with the piezoelectric printhead and the UV light source; and
an ink reservoir coupled to the piezoelectric printhead, the ink reservoir including an ink containing a bio-reactive indicator material, the ink adapted to cure in response to application of UV light from the UV light source.

20. The apparatus of claim 19, wherein the ink includes one or more ingredients that are adapted to bond to a polymeric substrate.

21. The apparatus of claim 19, wherein the ink includes a conductive ink containing a biological material.

22. The apparatus of claim 19, wherein the ink includes Polymerase Chain Reaction (PCR) reactants.

23. The apparatus of claim 19, wherein the ink includes an indicator material that reacts with Low Density Lipoprotein.

24. A piezoelectric printing system comprising:
a polymer substrate;
a first reservoir containing an etchant sufficient to etch the polymer substrate;
a second reservoir containing an ink that includes a bio-reactive indicator material, wherein the indicator material is adapted to facilitate detecting a characteristic of a biological sample disposed thereon or in proximity thereto;
a piezoelectric printhead in fluid communication with the first reservoir and the second reservoir; and
a controller adapted to control the printhead to enable etching of the polymer substrate via application of the etchant thereto to create a three-dimensional structure on or in the polymer substrate, resulting in an etched substrate in response thereto.

25. The system of claim 24, wherein the controller is further adapted to selectively deposit the indicator material on the substrate.

26. A method for printing one or more features on a polymer substrate, the method comprising:
employing a piezoelectric printer to form a microfluidic channel in or on the polymer substrate;
using the piezoelectric printer to print a lens material on the polymer substrate; and
using an UltraViolet (UV) light source that is coupled to one or more printheads of the piezoelectric printer to selectively harden the lens material and bond the lens material to the polymer substrate.

27. The method of claim 26, wherein employing further including selectively outputting an etchant via one or more nozzles of a piezoelectric printhead and employing the UV light source to vaporize etchant from the polymer substrate in a single printing pass.

28. A method for printing on a polymer substrate, the method comprising:
employing a piezoelectric printhead in communication with an etchant to selectively etch one or more three dimensional features in the polymer substrate;
using the piezoelectric printhead in communication with an ink to selectively print the ink on the polymer substrate in a predetermined relationship to the one or more three dimensional features, wherein the ink contains a chemical indicator;
employing an ultraviolet light source to cure ink that has been deposited on the polymer substrate; and
performing the above steps in a single printing pass.

29. A method for creating one or more desired features on a polymer substrate, the method comprising:
selectively etching the polymer substrate via selective application of an etchant, resulting in etched microfluidic channels in response thereto, wherein the application of the etchant is performed via a printing device;
selectively depositing lens material on the polymer substrate; and
curing the lens material via application of ultraviolet light.

30. The method of claim 29, further including performing two or more of the steps of claim 29 in a single printing pass.

31. The method of claim 29, further including depositing an ink on the polymer substrate via the printing device.

32. The method of claim 31, wherein the printing device includes a piezoelectric printhead.

33. The method of claim 31, wherein the printing device includes a piezoelectric printer.
